(19) United States
(12) Patent Application Publication
(10) Pub. No.: US 2013/0031616 A1
(43) Pub. Date: Jan. 31, 2013

(54) Methods and Systems for Enabling Multiple Accounts Support

(71) Applicants: Debajit GHOSH, Menlo Park, CA (US); Thomas TAYLOR, Redmond, WA (US); Wei HUANG, Seattle, WA (US); Francesco NERIERI, Santa Cruz, CA (US)

(72) Inventors: Debajit GHOSH, Menlo Park, CA (US); Thomas TAYLOR, Redmond, WA (US); Wei HUANG, Seattle, WA (US); Francesco NERIERI, Santa Cruz, CA (US)

(73) Assignee: Google Inc., Mountain View, CA (US)

(21) Appl. No.: 13/363,772

(22) Filed: Feb. 1, 2012

Related U.S. Application Data
(60) Provisional application No. 61/438,603, filed on Feb. 1, 2011.

(51) Int. Cl. H04L 9/32

(52) U.S. Cl. 726/5

(57) ABSTRACT

Embodiments allow communication for a first and second account on one device to be sent and received over a single socket connection. A unique identifier may be associated with each account on the device. Communications sent from each account on the device may be encapsulated with the unique identifier for the account. Similarly, communications received for each account on the device may be encapsulated with the unique identifier for the account by a mobile endpoint.

### CROSS REFERENCE TO RELATED APPLICATIONS

This application claims the benefit of U.S. Provisional Appl. No. 61/438,603 filed Feb. 1, 2011, which is hereby incorporated by reference in its entirety.

### BACKGROUND

Many mobile device users communicate with peers, colleagues and friends using various messaging features of their devices. For example, software packages such as GOOGLE TALK from Google Inc. of Mountain View, Calif., allow users to quickly communicate with others using short messages exchanged between two or more users. Each mobile device user may have an account, such as an e-mail account or instant messaging account, that may be tied to their e-mail address or other identification.

Certain users may have multiple accounts that they use to communicate. For example, a user may have a personal account and a work account. Each account may be used to communicate with a particular group of people. Using both accounts simultaneously is often desirable.

### BRIEF SUMMARY

Embodiments relate to methods and systems of efficiently enabling support for multiple accounts through a single socket connection. In an embodiment, a system for multiple account support is disclosed. The system may include an account management module that associates a unique identifier with an account of a first user. The first user may have a plurality of accounts. Further, the system may include a mobile endpoint that receives a message from an account of the first user intended for a second user. The mobile endpoint may also receive a message from the second user to the account of the first user. The system may also include a mobile endpoint chat helper, which encapsulates the message from the second user to the account of the first user with the unique identifier. The mobile endpoint chat helper may also strip the unique identifier associated with the account from the message from the account of the first user to the second user.

In an embodiment, a system for enabling multiple account support over a single socket connection is disclosed. The system includes a socket connection module that creates an open socket connection for a first account of a user. Also included is an authentication module that receives authentication credentials associated with a second account of the user. The authentication module may also receive authentication credentials for the first account of the user. Finally, the system may include a socket binding module that binds the second account to the created open socket connection.

In an embodiment, a method for enabling multiple account support over a single socket connection is disclosed. The method may include associating a unique identifier with an account of a first user, who may have a plurality of accounts. The method may also include receiving a first message from an account of the first user, intended for a second user. The message may be stripped of a unique identifier associated with the account of the first user. Further, a second message from the second user, intended for the account of the first user, may be received. The second message may be encapsulated with the unique identifier associated with the account of the first user

In an embodiment, a method for enabling multiple account support over a single socket connection is disclosed. The method includes detecting an open socket connection for a first account of a user. Authentication credentials associated with a second account of the user may be received. A request to bind the second account to the open socket connection for the first account may be sent. Further, a unique identifier associated with the second account may be received. The second account may be bound to the detected open socket connection.

Further embodiments, features, and advantages of the invention, as well as the structure and operation of the various embodiments of the invention are described in detail below with reference to accompanying drawings.

### BRIEF DESCRIPTION OF THE DRAWINGS/FIGURES

Embodiments of the invention are described with reference to the accompanying drawings. In the drawings, like reference numbers may indicate identical or functionally similar elements. The drawing in which an element first appears is generally indicated by the left-most digit in the corresponding reference number.

FIG. 1 is a diagram of a mobile connection server system in accordance with an embodiment.

FIG. 2 is a diagram of a mobile device connection system in accordance with an embodiment.

FIG. 3 is a flow diagram of a method for enabling multiple account support over a single socket connection in accordance with an embodiment.

FIG. 4 is a flow diagram of a further method for enabling multiple account support over a single socket connection in accordance with an embodiment.

FIG. 5 is a flow diagram of a method for supporting multiple account communication over a single socket connection in accordance with an embodiment.

### DETAILED DESCRIPTION

While the present invention is described herein with reference to the illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

In the detailed description of embodiments that follows, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Mobile devices, such as mobile telephones, smartphones, and tablet computers, may utilize one or more e-mail accounts, instant messaging accounts, communications accounts, or other accounts, in order to deliver content to users and allow users to communicate with others. Messages communicated between users may include text, audio, video, or any combination thereof. The term communication may also refer to a message. For example, a user may have two accounts tied to two e-mail addresses, one for work and one for personal use. Thus, the user may have, for example and without limitation, john.smith.work@example.com, as well as, john.smith.home@example.com.

Although the user's two accounts may share a domain name (example.com), typically, two physical connections are created between the user's device and the communication server to facilitate the user's communication. Additionally, if the user's two accounts do not share a domain name, two physical connections between the user's device and the communication server may be created as well. For example, if both accounts are instant message chat accounts, both accounts may create individual socket connections to an appropriate instant message server on a previously specified port. Each socket connection may require that an amount of data be transferred to establish the connection, as well as to maintain the connection.

Such an amount of data for multiple connections may be appropriate for a desktop computer with a broadband or other fast network connection. On a mobile device, however, the data transferred in the process of creating and maintaining each socket connection must be maintained over a cellular, wi-fi, or other type of wireless network, which may not provide as much bandwidth as a typical broadband connection. Further, cellular network providers may charge users depending on the amount of bandwidth used. Reducing the amount of data required for multiple messaging accounts may be accomplished by supporting multiple accounts over a single socket connection.

In order to support multiple accounts over a single socket connection, both client devices, such as mobile telephones, and server-side devices, such as mobile endpoints, may need to be multiple account aware. Embodiments describe both client devices and server devices that support multiple accounts.

### Systems

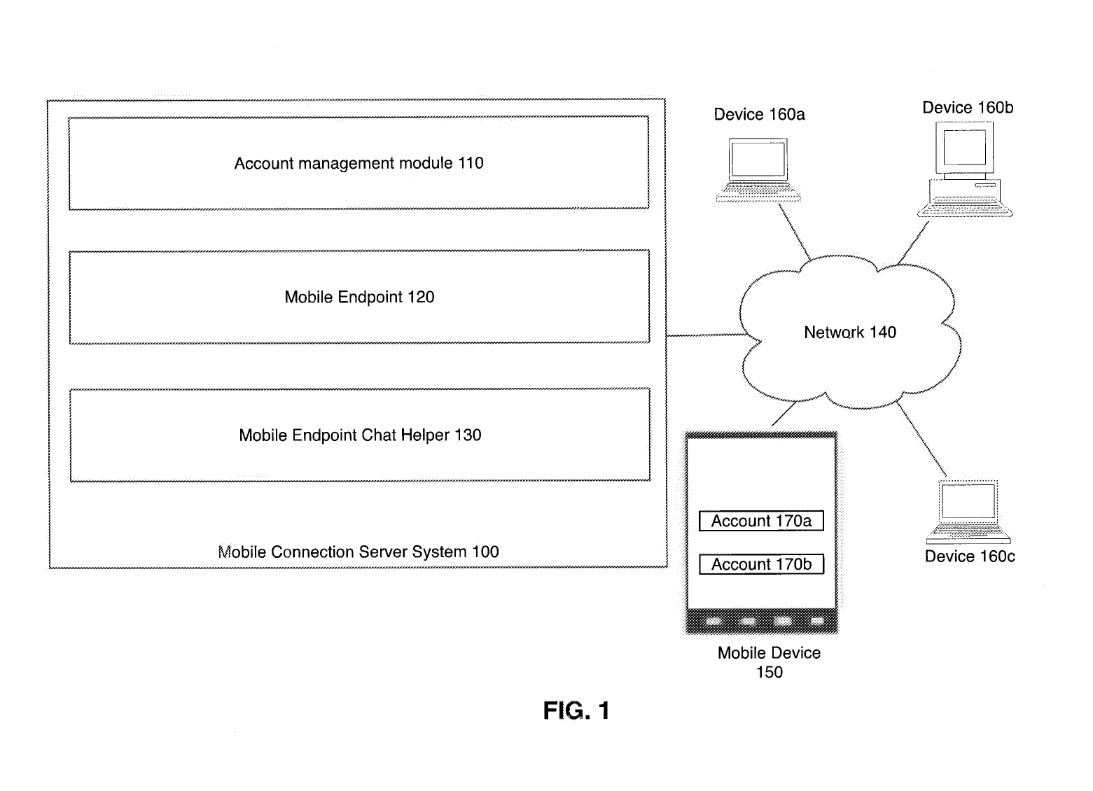

FIG. 1 is a diagram of an exemplary mobile connection server system 100 used to implement embodiments described herein, as well as computing devices 160, mobile device 150, and network 140. Mobile connection server system 100 and each of its components may be implemented in hardware, software, firmware, or any combination thereof. System 100 may be implemented on any computing device. For example, the computing device may be a server, a clustered computing environment or a server farm. A computing device can include, but is not limited to, a device having a processor and memory for executing and storing instructions. Software may include one or more applications and an operating system. Hardware can include, but is not limited to, a processor, memory and graphical user interface display. The computing device may also have multiple processors and multiple shared or separate memory components.

System 100 may include an account management module 110. Account management module 110 may associate user accounts, such as e-mail accounts, instant messaging accounts, calendar accounts, and other accounts, with a unique identifier.

System 100 may also include a mobile endpoint 120. Mobile endpoint 120 may receive messages sent from one user to another. For example, mobile endpoint 120 may receive messages from a user account on mobile device 150 intended for one or more of computing devices 160 (shown individually as computing devices 160a-160c). Mobile endpoint 120 may also receive messages from one of computing devices 160 intended for a user account on mobile device 150. Mobile device 150 may have one or more accounts associated with it, such as account 170a and account 170b. Although mobile device 150 is shown as having two accounts 170a and 170b associated with it, mobile device 150 is not limited to two accounts, and may have more than two accounts associated with it. For example, mobile device 150 may have up to n accounts, where n is a positive number.

System 100 may further include one or more mobile endpoint chat helpers 130. As will be described in further detail below, mobile endpoint chat helpers 130 may be responsible for encapsulating a message from one of computing devices 160 intended for an account on mobile device 150 with a unique identifier associated with the intended account. Further, mobile endpoint chat helpers 130 may be responsible for removing or stripping a unique identifier associated with an account on mobile device 150 from a message sent from an account on mobile device 150 intended for a computing device 160. System 100 may include multiple mobile endpoint chat helpers 130, and associate each mobile endpoint chat helper with a particular account.

Each mobile endpoint chat helper 130 may also deliver a message once it is stripped of a unique identifier. Further, each mobile endpoint chat helper 130 may call mobile endpoint 120 to deliver a message once it is appropriately wrapped with a unique identifier.

System 100 may be connected to a network 140 to facilitate communication with computing devices 160a-160c and mobile device 150. Network 140 may be a local area network, medium area network, or wide area network such as the Internet. Computing devices 160a-160d may be laptop computers, desktop computers, mobile devices, or other devices.

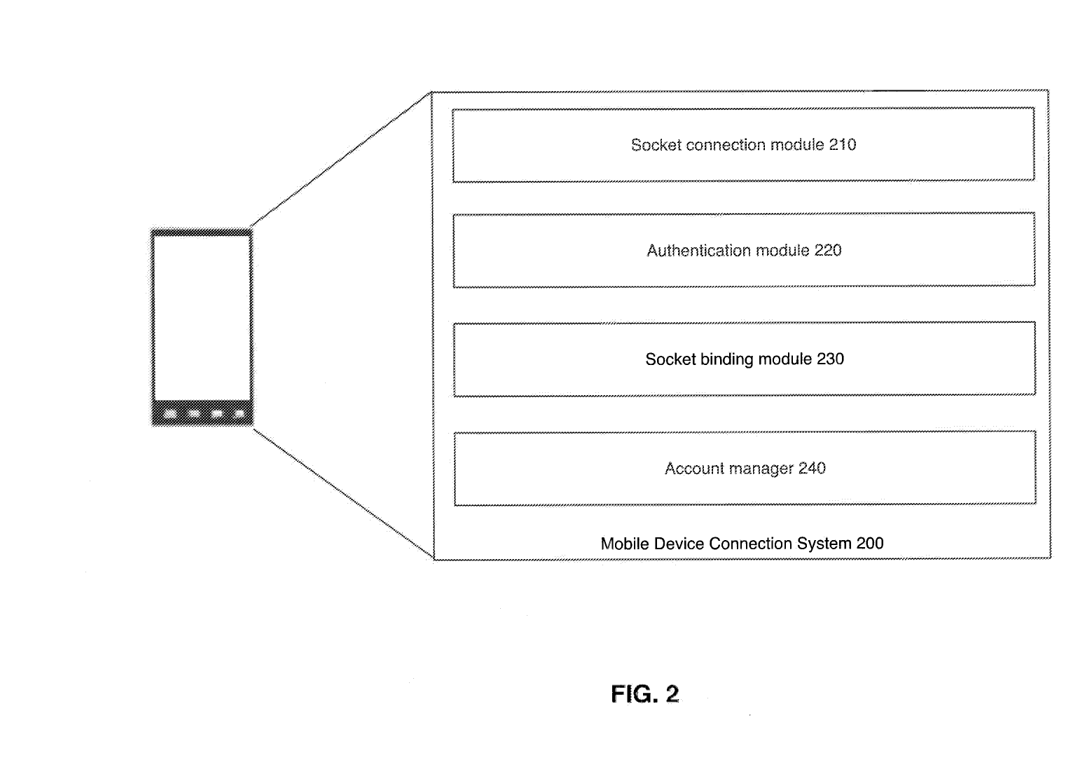

FIG. 2 is a diagram of a mobile device connection system 200 for enabling multiple account support over a single socket connection, in accordance with an embodiment. System 200 may be implemented, for example, on a mobile device such as a mobile telephone, smartphone, or tablet device. System 200 and each of its components may be implemented in hardware, software, firmware, or any combination thereof. Although system 200 will be referred to herein as implemented on a mobile device, one of skill in the art will recognize that system 200 may also be implemented on any end-user device without departing from the spirit and scope of the present invention.

System 200 may include a socket connection module 210. Socket connection module 210 may open a socket connection for a first messaging account on the device implementing system 200.

System 200 may also include an authentication module 220. Authentication module 220 may receive or accept authentication credentials for an account of a user, such as a messaging account, e-mail account, calendar account, or other account. Authentication credentials may include a user name, password, domain, and/or any other information required to establish a connection for an account.

System 200 may include a socket binding module 230. Socket binding module 230 may send a request to bind an account to a socket connection created by socket connection module 210. The request to bind an account sent by socket binding module 230 may include authentication credentials received by authentication module 220. Socket binding module 230 may also receive a response to the request to bind an account. Such a response may be received from a mobile connection server system 100, and contain a unique identifier for an account on the mobile device implementing system 200.

Additionally, system 200 may include an account manager 240. Account manager 240 may instruct socket binding module 230 to send a request to bind an account when account manager 240 detects an open socket connection. Account manager 240 may also maintain a record of unique identifiers and accounts. Account manager 240 may also encapsulate messages originating from accounts on system 200 with the unique identifier associated with the account. Account manager 240 may also be responsible for appropriately handling messages received by the end-user device implementing system 200 based on the unique identifier of each message.

### Methods

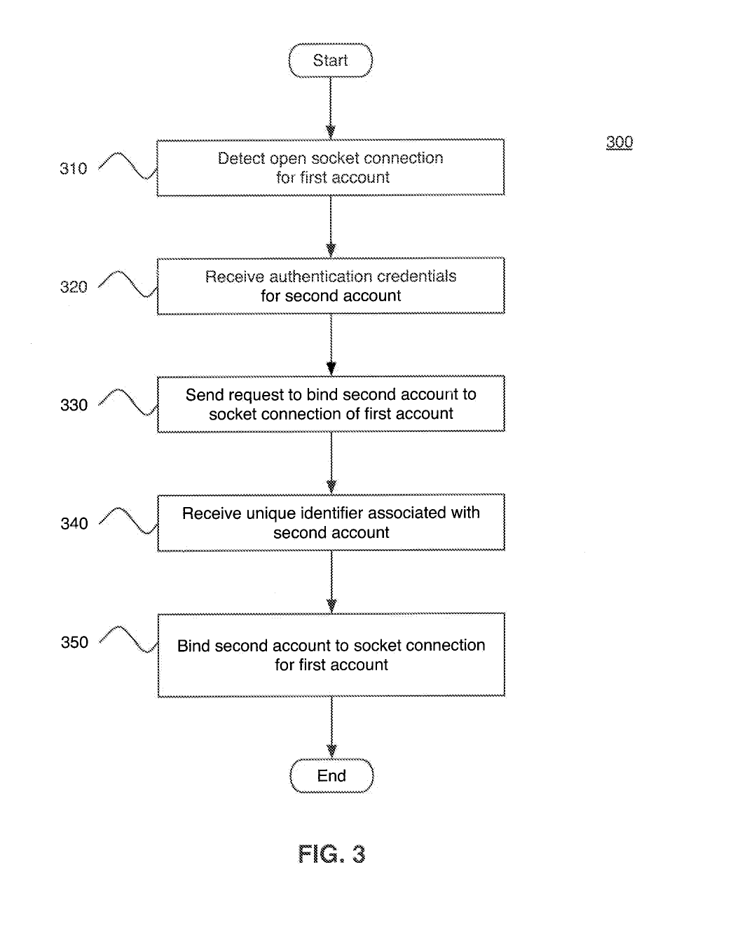

FIG. 3 is a flow diagram of a method 300 for enabling multiple account support over a single socket connection. At block 310, an open socket connection for a first account of a user may be detected. Detecting an open socket connection may be performed by, for example, socket connection module 210 or account manager 240 of FIG. 2. The first account may be an instant messaging account, e-mail account, calendar account, or other type of account. The account may be linked to or related to an e-mail address or other identifier.

At block 320, authentication credentials associated with a second account of the user are received. Authentication credentials may include a user name, password, domain, or any other credentials required to authenticate with a messaging server or provider. The second account may also be an instant messaging account, e-mail account, calendar account, or other type of account. Authentication credentials may be received by, for example, authentication module 220 of FIG. 2.

In response to the received authentication credentials, at block 330, a request to bind the second account to the detected open socket connection of the first account may be sent. The request may include the authentication credentials received at block 320 and any additional information necessary to bind the second account. The request to bind the second account to the detected open socket connection may be sent by, for example, socket binding module 230 of FIG. 2.

At block 340 then, a unique identifier may be received and associated with the second account of the user. In an embodiment, a unique identifier is received for the first account of the user as well. A unique identifier may be received and associated with the second account of the user by, for example, account manager 240 of FIG. 2.

At block 350, the second account is bound to the detected open socket connection. Communications from the second account or to the second account may be delivered via the open socket connection detected at block 310, and may be encapsulated with the unique identifier received at block 340. In an embodiment, the second account's buddy list or contact list may be received after the second account is bound to the detected open socket connection. Further, if the second account is an e-mail account, the second account's e-mail messages may be received after the second account is bound to the detected open socket connection. The second account to the open socket connection may be bound by, for example, socket binding module 230 of FIG. 2.

In an embodiment, authentication credentials of a third account may be received. Accordingly, blocks 320, 330, 340, and 350 of method 300 may be repeated for the third account. Embodiments may support any number of accounts by repeating blocks 320-350 of method 300 for each additional account.

In an embodiment, the various steps of method 300 may be implemented on a mobile computing device, such as a mobile telephone, smartphone, or tablet device, in order to make the device multiple account aware. As mentioned above, in order to properly communicate messages for multiple accounts over a single socket connection, a messaging server may also need to be multiple account aware.

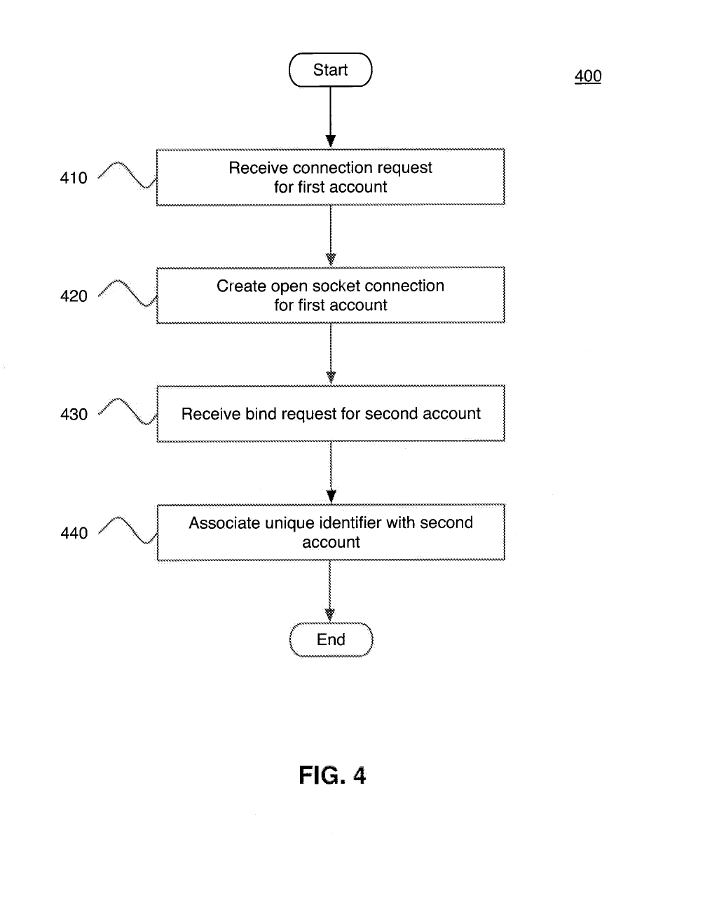

FIG. 4 is a flow diagram of a method 400 for enabling multiple accounts. Method 400 may be implemented and executed, for example and without limitation, by a messaging server. In an embodiment, method 400 may be executed by a mobile connection server system, such as mobile connection server system 100 of FIG. 1.

At block 410, a connection request is received for a first account. Such a connection request may be received, for example and without limitation, from a client. The connection request may include authentication credentials, such as a username, password, domain, and other details necessary for a first account. The connection request may be received by, for example, mobile endpoint 120 of FIG. 1.

In response, at block 420, a socket connection may be created for the connection request. Depending on the type of connection request received at block 420, the socket connection may be created with a particular device on a particular communications port. The socket connection may be created by, for example, mobile endpoint 120 of FIG. 1.

At block 430, a bind request is received for a second account. The bind request may be received from the same client that sent the initial connection request at block 410. In an embodiment, the bind request received at block 430 may be sent by a client implementing embodiments of method 300. Thus, the bind request may include authentication credentials such as a username, password, domain, and other such necessary details. The bind request may be received by, for example, mobile endpoint 120 of FIG. 1 or account management module 110 of FIG. 1.

In response to the bind request, at block 440, a unique identifier is associated with each of the first and second accounts. A unique identifier may be stored in a map or database and associated with an account. For example, account management module 110 may associate a unique identifier with each of the first and second accounts. Further, at block 440, a mobile endpoint chat helper, such as mobile endpoint chat helper 130 of FIG. 1, may be created to appropriately handle messages from each of the first and second accounts.

In an embodiment, a bind request may be received for a third account, as in block 430. Thus, in accordance with block 440, a unique identifier may be associated with the third account. Embodiments may support any number of accounts by repeating blocks 430 and 440 for each additional account.

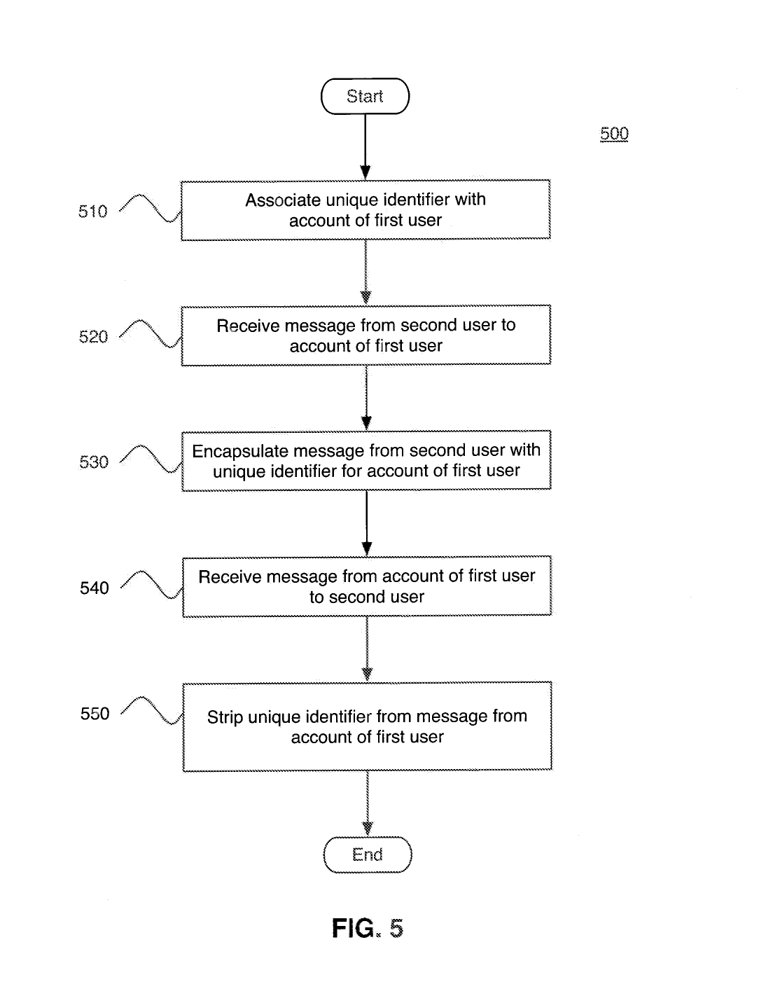

In order to properly communicate messages for two or more accounts, over a single open socket connection, a method for multiplexing messages may be needed. FIG. 5 is a flow diagram of such a method 500 for multiplexing messages. In an embodiment, method 500 may be executed by a mobile connection server system communicating with one or more mobile devices, messaging clients, or other devices.

At block 510, a unique identifier is associated with an account of a first user. Such a unique identifier may be associated as part of an execution of method 400, described above. The first user may have a plurality of accounts, such as account 170a and account 170b of FIG. 1; further, each account may be associated with a unique identifier. Each account may also have a mobile endpoint chat helper. In an embodiment, the first user may have more than two accounts.

At block 520, a message from a second user, such as device 160a, intended for an account on mobile device 150, is received. For example, a message may be intended for account 170a on mobile device 150. The message may be received at a mobile endpoint, such as mobile endpoint 120 of FIG. 1.

In order to properly deliver the message, at block 530, the message may be encapsulated with the unique identifier associated with the particular account of the first user. For example, mobile endpoint chat helper 130 of FIG. 1 may encapsulate the message with the unique identifier associated with account 170a. Thus, when the message is communicated to the mobile device, the mobile device may be able to deliver the message to the correct account, using the unique identifier.

At block 540, a message from an account of the first user, intended for a second user, is received. For example, a message from account 170a intended for device 160a may be received. The message may have been encapsulated with the unique identifier for the account of the first user that is sending the message. For example, mobile device 150, implementing method 300, may encapsulate the message with the unique identifier of the account of account 170a. The message may be received by a mobile endpoint, such as mobile endpoint 120 of FIG. 1.

At block 550, the unique identifier may be stripped from the message from account 170a. This may be because the recipient of the message, device 160a, does not require such a unique identifier to process and receive the message. In an embodiment, a mobile endpoint chat helper, such as mobile endpoint chat helper 130 of FIG. 1, is responsible for stripping the unique identifier.

In an embodiment, the message from an account of the first user intended for the second user may be delivered to the second user. For example, the mobile endpoint chat helper may deliver the message over a network. In a further embodiment, the message may be delivered to a session server, which further processes the message. In accordance with an embodiment, a separate session server may not be necessary.

In an embodiment, the message intended for an account of the first user, may be delivered to the device associated with the account. The device may appropriately handle the delivered message.

Embodiments may be implemented by a computing system, such as a server. For example, method 400 and 500 may be executed by a messaging server. Thus, messages sent from a client device, such as a mobile telephone or tablet computer, may be communicated to a server executing method 500 to properly route messages.

In an embodiment, messages that are communicated between accounts and users may be consistent with the XMPP standard. Accordingly, in an embodiment, messages may be communicated using extensible markup language, or XML. Thus, messages communicated according to embodiments may be XML stanzas, communicated in an XML stream.

In a further embodiment, XML stanzas may be of the type <message/>, <presence/>, or <iq/>.

In an embodiment, the mobile connection server system may store a map of unique identifiers and accounts. Such a map may be stored, for example and without limitation, in a database implemented in hardware or software.

In an embodiment, messages from multiple accounts may be exchanged directly between an account of a first user and a second user in a peer-to-peer fashion. For example, a mobile device, such as mobile device 150, may implement elements of method 500 of FIG. 5 to multiplex messages sent directly to computing devices 160. Similarly, each of computing devices 160 may implement elements of method 500 to receive and correctly direct messages based on the unique identifier associated with each message. In this embodiment, each of mobile device 150 and computing devices 160 may implement all or some components of a mobile connection server system such as mobile connection server system 100 of FIG. 1 to facilitate direct communication between mobile device 150 and computing devices 160.

### Example

Below is an example of a timeline to further assist in understanding embodiments described herein. To begin, a mobile device user may wish to communicate with two instant messaging accounts on his mobile device. Such an instant messaging account may be a GOOGLE TALK account, provided by Google Inc. of Mountain View, Calif.

The mobile device user may be currently communicating with a first instant messaging account, john.smith.home@example1.com. The first instant messaging account may have a currently open socket connection with a mobile connection server, such as a GOOGLE TALK server, on a particular communication port. Further, the mobile device user may be communicating with a second instant messaging user, such as a friend at friend@example.com.

The mobile device user may at some point wish to communicate with colleagues using a second instant messaging account, john.smith.work@example2.com. For example, the mobile device user may wish to communicate with an instant messaging user such as a colleague at colleague@example.com. To accomplish this, the mobile device user may provide authentication information such as his username, password, and other required information.

The authentication information may be received by the user's mobile device. In response, for example and without limitation, the mobile device's socket binding module may send a socket binding request to the mobile connection server containing the authentication information, and requesting to bind the second account to the open socket connection of the first account. In response to the socket binding request, the mobile connection server may send a unique identifier for the second instant messaging account. For example, the mobile connection server may send the number “2” for the second account, john.smith.work@example2.com. In an embodiment, the mobile connection server may also send a unique identifier for the first messaging account, john.smith.home@example1.com, such as the number “1”. Further, the second messaging account may be bound to the currently open socket connection for the first account. Additionally, in accordance with embodiments, a mobile endpoint chat helper may be created or associated with each account.

Subsequently, instant messages from each account may be encapsulated with the unique identifier associated with the particular account. Thus, if the mobile device user wishes to send a message from his personal account to his friend, the mobile device may send a XML stanza with the unique identifier “1” to the mobile connection server. In accordance with embodiments, the mobile endpoint may call the appropriate mobile endpoint chat helper. In accordance with method 500, the mobile endpoint chat helper may strip the unique identifier “1”, parse the XML stanza, and deliver the message according to the information contained in the stanza. Delivering the message may include sending the message to a session server for the recipient, which handles delivery to the recipient.

If the mobile device user's friend at friend@example.com wishes to send a message to the personal account of the mobile device, upon receipt of such a message, the mobile endpoint may call the appropriate mobile endpoint chat helper. The mobile endpoint chat helper may then encapsulate the message with the unique identifier of the personal account of “1”. The mobile endpoint may then communicate this encapsulated message to the mobile device. The mobile device may then handle the encapsulated message and present it to the user in accordance with user preferences, for example.

Similarly, messages exchanged between the mobile device user's colleague and his work account may be associated with the unique identifier for the work account of “2”. Thus, the mobile connection server may appropriately handle incoming and outgoing messages according to embodiments disclosed herein and the example above. Further, the mobile device may appropriately handle messages according to the example above as well.

Although the above example is described with respect to two accounts, in accordance with embodiments, more than two accounts may be supported over a single socket connection as well.

### CONCLUSION

Communicating using multiple accounts over a single channel may provide a number of advantages. For example, on a mobile device, such as a smartphone, maintaining a single socket connection requires less processing power than multiple socket connections. A reduction in processing power may lead to less battery power being used and greater battery life for a user. Further, as explained above, maintaining a single socket connection may consume less data bandwidth, leading to lower data costs for the mobile device user.

Embodiments may be directed to computer products comprising software stored on any computer usable medium. Such software, when executed in one or more data processing device, causes a data processing device(s) to operate as described herein.

Embodiments may be implemented in hardware, software, firmware, or a combination thereof. Embodiments may be implemented via a set of programs running in parallel on multiple machines.

The summary and abstract sections may set forth one or more but not all exemplary embodiments of the present invention as contemplated by the inventor(s), and thus, are not intended to limit the present invention and the appended claims in any way.

Embodiments of the present invention have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments.

What is claimed is:

1. A computer-implemented method for enabling multiple account support over a single socket connection, comprising:
receiving authentication credentials associated with a first account of a user;
opening a socket connection for the first account;
receiving a unique identifier for the first account;
communicating one or more messages for the first account over the socket connection to a server device;
receiving authentication credentials associated with a second account of the user;
detecting the open socket connection for the first account of the user;
sending, to the server device, a request to bind the second account to the open socket connection;
receiving a unique identifier for the second account from the server device;
binding the second account to the detected open socket connection; and
communicating one or more messages for the first account and second account over the open socket connection to the server device, wherein messages for the first account are encapsulated with the unique identifier for the first account, and wherein messages for the second account are encapsulated with the unique identifier for the second account.

2. The method of claim 1, wherein the socket connection is an XMPP connection.

3. The method of claim 1, further comprising:
receiving a contact list for the first account; and
receiving a contact list for the second account over the detected open socket connection.

4. The method of claim 1, wherein the first account is one of an instant messaging account or an e-mail account.

5. The method of claim 1, wherein the authentication credentials include a user name and password.

6. The method of claim 1, wherein the one or more messages comprise XML stanzas.

7. A computer-implemented method for enabling multiple account support over a single socket connection, comprising:
detecting an open socket connection for a first account of a user;
receiving authentication credentials associated with a second account of the user;
sending, to a server device, a request to bind the second account to the open socket connection;
receiving a unique identifier for the second account from the server device;
binding the second account to the detected open socket connection; and
communicating one or more messages for each of the first account and second account over the open socket connection to the server device.

8. The method of claim 7, wherein the socket connection is an XMPP connection.

9. The method of claim 7, further comprising:
receiving a contact list for the first account; and
receiving a contact list for the second account over the detected open socket connection.

10. The method of claim 7, wherein the first account is one of an instant messaging account or an e-mail account.

11. The method of claim 7, wherein the authentication credentials include a user name and password.

12. The method of claim 7, wherein the one or more messages comprise XML stanzas.

13. A system for enabling multiple account support over a single socket connection, comprising:
a memory;
a processor;
an authentication module that receives authentication credentials associated with a first account and a second account of a user;
a socket connection module that creates an open socket connection for the first account of the user;
a socket binding module that sends a request to bind the second account to the created open socket connection, receives a unique identifier for each of the first account and the second account, and that further binds the second account to the created open socket connection; and
an account management module that stores the unique identifier for each of the first account and second account, encapsulates messages for transmission for the first account with the unique identifier for the first account, and that further encapsulates messages for transmission for the second account with the unique identifier for the second account.

14. The system of claim 13, wherein the socket connection module creates an open XMPP socket connection for the first account of the user.

15. The system of claim 13, wherein the account management module communicates messages for the first account and for the second account to a server device over the open socket connection.

16. A system for enabling multiple account support over a single socket connection, comprising:
a memory;
a processor;
an account management module that associates a unique identifier with an account of a first user, wherein the first user has a plurality of accounts;
a mobile endpoint that receives a message from the account of the first user to a second user, and a message from the second user to the account of the first user; and
a mobile endpoint chat helper that encapsulates the message from the second user with the unique identifier associated with the account of the first user, and that strips the unique identifier associated with the account from the message from the account of the first user,
wherein the mobile endpoint further delivers the message from the second user, encapsulated with the unique identifier, to a device associated with the account of the first user, and
wherein the mobile endpoint further delivers the message from the account of the first user, stripped of the unique identifier, to a device associated with the second user.

17. The system of claim 16, further comprising a database that stores a map of the unique identifier and the account of the first user.
